(19) United States
(12) Patent Application Publication
(10) Pub. No.: US 2016/0088403 A1
(43) Pub. Date: Mar. 24, 2016

(54) HEARING ASSISTIVE DEVICE AND SYSTEM

(71) Applicants: Clarke LAMBE, Scottsdale, AZ (US); CRYSTAL SOUND, LLC, Scottsdale, AZ (US)

(72) Inventor: Clarke Lambe, Scottsdale, AZ (US)

(21) Appl. No.: 14/891,650

(22) PCT Filed: May 15, 2014
(86) PCT No.: PCT/US2014/038210

§ 371 Date: Nov. 16, 2015

Related U.S. Application Data
(60) Provisional application No. 61/824,789, filed on May 17, 2013.

(51) Int. Cl. H04R 25/02; G06F 3/16; H04R 25/00

(52) U.S. Cl. CPC H04R 25/02; H04R 25/43; H04R 25/505; G06F 3/167; H04R 25/554; H04R 25/652; H04R 2225/021; H04R 2225/43; H04R 2225/63; H04R 2460/05

(57) ABSTRACT

A hearing assistive device and method of using the same comprising receiving a first audio signal from an ambient microphone, receiving a second audio signal from a directional microphone, mixing the first and second audio signals according to a preference of the first user, and projecting the mixed first and second audio signals into an ear of the first user. The method can further comprise dampening ambient sound arriving directly at the ear by 5-30 decibels, by disposing an occlusive earpiece within the ear to reduce the ambient sound, and projecting the mixed first and second audio signals from a speaker into the ear of the first user to indirectly provide a desired volume of ambient sound to the ear of the first user. The method can further include establishing a group through at least one wireless handheld communication device to facilitate transmission among multiple hearing assistive devices.

### CROSS-REFERENCE TO RELATED APPLICATIONS

This application claims the benefit of U.S. Provisional Application No. 61/824,789 filed May 17, 2013, entitled “Hearing Assistive Device and System,” the entirety of the contents of which are incorporated herein by this reference.

### TECHNICAL FIELD

The disclosure relates to a hearing assistive device and, more particularly, to a method and system of using the hearing assistive device(s) to assist a hearing impaired user(s).

### BACKGROUND

Individuals with impaired hearing can often experience difficulty and discomfort in relating and interacting with other people in everyday environments. To better facilitate interactions with other people and their environments, hearing-impaired individuals often rely on hearing aids as a way to improve hearing. Traditional hearing aids generally include a microphone for collecting sound, an electronic amplifier to make the sound louder, and a speaker for projecting the amplified sound (acoustic energy) from the earphone to the user's eardrum.

With significant size and weight reductions of hearing aids, hearing aids offer greater cosmetic appeal by being less visible to others. However, the miniaturization of traditional hearing aids requires greater manual dexterity to operate traditional hearing aids. Furthermore, traditional hearing aids also have difficulty in providing satisfactory hearing improvements to users conversing in environments with significant levels of ambient background noise such as in restaurants.

### BRIEF DESCRIPTION OF THE DRAWINGS

FIGS. 1A-1D illustrate a plurality of hearing assistive devices in accordance with embodiments of the disclosure.

FIGS. 2A-2B illustrate a method of controlling hearing assistive devices in accordance with embodiments of the disclosure.

FIG. 3 illustrates a system in which a plurality of hearing assistive devices operate together in accordance with embodiments of the disclosure.

FIG. 4 illustrates a method of exercising control in a system comprising a plurality of hearing assistive devices.

FIG. 5 illustrates another method of exercising control in a system comprising a plurality of hearing assistive devices.

FIG. 6 illustrates another method of exercising control in a system comprising a plurality of hearing assistive devices.

FIGS. 7A-7B illustrate another method of exercising control in a system comprising a plurality of hearing assistive devices.

FIG. 8 illustrates a system in which a plurality of hearing assistive devices operate in accordance with embodiments of the disclosure.

### DETAILED DESCRIPTION

The present invention is described in one or more embodiments in the following description, with reference to the figures, in which like numerals represent the same or similar elements. While the description is written in terms of the best mode, it will be appreciated by those skilled in the art that it is intended to cover alternatives, modifications, and equivalents as may be included within the spirit and scope of the invention as defined by the appended claims and their equivalents as supported by the following disclosure and drawings. In the description, numerous specific details are set forth, such as specific configurations, compositions, and processes, etc., in order to provide a thorough understanding of the disclosure. In other instances, well-known features and processes have not been described in particular detail in order to not unnecessarily obscure the disclosure. Furthermore, the various embodiments shown in the FIGs. are illustrative representations and are not necessarily drawn to scale.

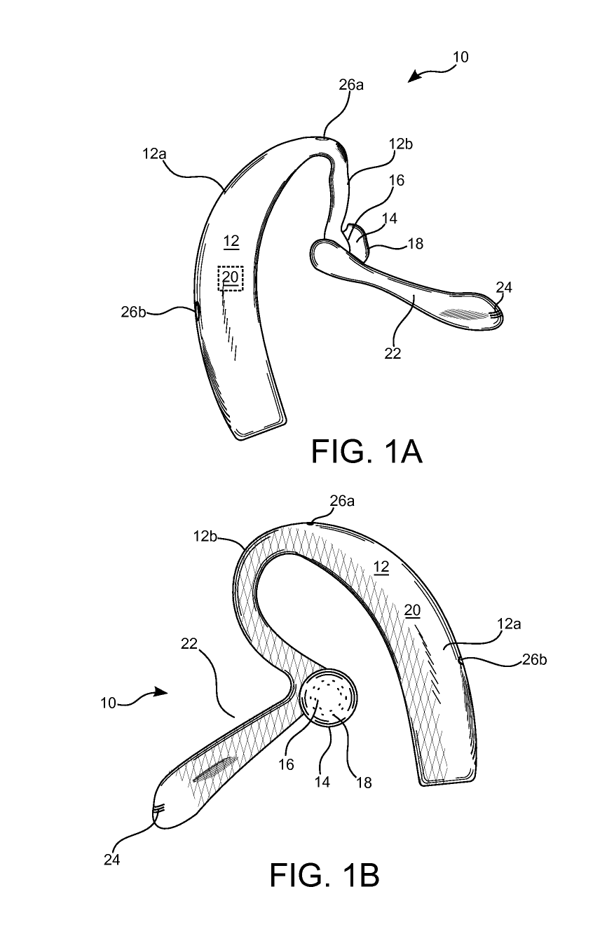

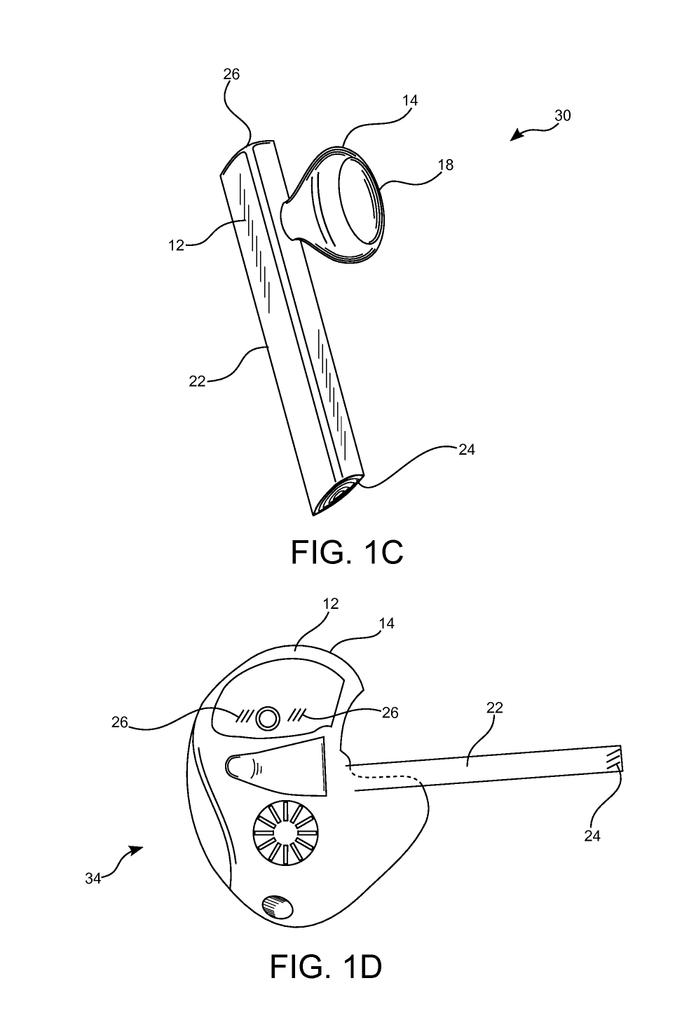

FIGS. 1A-1D show hearing assistive devices 10, 30, and 34 that are configured to improve the hearing of a user or hearing-impaired person and assist the hearing-impaired person to better understand speech, especially in environments with high background noise, such as in restaurants. Hearing assistive device 10, 30, and 34 can operate individually or as part of a system including multiple hearing assistive devices connected as part of a system via communication links, which can be provided, for example, by handheld wireless communication devices such as smart phones. Hearing assistive devices 10, 30, and 34, either individually or as part of a system, can create a quiet listening environment conducive to facilitating conversations between 2 or more persons in environments that would otherwise inhibit or discourage conversation for the hearing impaired. Additionally, hearing assistive device 10 can gather, filter, and transmit targeted sound to a user in the quiet listening environment to improve hearing and understanding of speech for the user.

FIG. 1A shows a side profile view of hearing assistive device 10. Similarly, FIG. 1B shows a side profile view of hearing assistive device 10 opposite the side view shown in FIG. 1A. Assistive device 10 can comprise a housing 12, which optionally comprises a back or behind the ear portion 12a and a connecting portion 12b. Housing 12 is made by molding, casting, or other suitable process and is formed of metals, plastics, polymers, monomers, acrylics, or other suitable material to provide a structurally sound housing or shell. Housing 12 can further comprise connecting portion 12b that extends from back potion 12a toward an ear canal of a user that can be coupled or attached to occlusive earpiece or ear canal fitting 14.

FIGS. 1A and 1B show occlusive earpiece 14 can be coupled to housing 12. Occlusive earpiece 14 is configured to be disposed within a user's ear or ear canal and to be molded or conformally fit within or adjacent to the ear canal. Occlusive earpiece 14 can be friction fit at a an interface of a user's outer ear and ear canal, being held in place, for example, by the user's tragus and antitragus. Occlusive earpiece 14 can also be disposed within the deeper bony portion of the user's ear to provide better occlusion of ambient sound. Occlusive earpiece 14 can be custom-formed to match the contours of a particular user's ear. In an embodiment, the occlusive earpiece can be made of solid or rigid material that is customizably formed to match a shape of the wearer's ear and conformally fits to the user's ear. Alternatively, occlusive earpiece 14 can be made of a deformable material that includes a first shape before being inserted into a user's ear and subsequently acquires a second shape after being inserted in to the user's ear such that occlusive earpiece 14 conformally matches or mirrors the contours of the user's ears. Additionally, occlusive earpiece 14 can be custom formed and deformable.

Thus, occlusive earpiece 14 can include a material composition comprising one or more portions of low-resilience polyurethane (memory foam), polyethylene terepthalate, polyvinyl, neoprene, shaped and hardened liquid silicone, or other suitable material. The conformally worn occlusive earpiece 14 reduces a level of interfering ambient noise arriving at a user's inner ear and protects a user against hazardous noise. In an embodiment, the mechanical properties of the occlusive earpiece provide a passive or mechanical noise reduction rating (NRR) in a range of about 5-30 decibels (dB), and in some instances in a range of about 10-15 dB. Accordingly, ambient noise is substantially prevented from directly arriving at a user's inner ear due to the size, shape, position, and material of occlusive earpiece 14.

A speaker or earphone 16 can be connected to, disposed within, or formed as an integral part of, housing 12 or occlusive earpiece 14. Alternatively, speaker 16 is disposed within housing 12 and can be disposed within a cavity or storage area of back portion 12a of housing 12. Sound from speaker 16 is projected from hearing assistive device 10 through sound projection point or points 18, which can be formed at an outer edge or periphery of occlusive earpiece 14, and are directed toward the user's ear canal or inner ear. Speaker 16 is coupled and electrically connected to an electronic module 20.

FIGS. 1A and 1B also show an electronic module 20 can be formed as part of hearing assistive device 10 and be disposed within housing 12. Electronic module 20 can include, for example, one or more amplifiers, processors, receivers, antenna, batteries, analog or digital circuits such as DSP, ASIC, memory, or other signal processing circuit, and may further contain IPDs such as inductors, capacitors, and resistors, for signal processing. Amplifiers within electronic module 20 increase the amplitude of an electronic signal received from a microphone in order to make the sound received by the microphone louder for the user. The processor and filter can adjust one or more waveforms of electronic signals received through the microphones, receivers, or other devices.

In FIGS. 1A and 1B, an optional boom or arm 22 is shown coupled to housing 12 or occlusive earpiece 14. A directional front facing microphone 24 can be attached to or disposed within a distal end of boom 22 and positioned opposite housing 12 and occlusive earpiece 14. Alternatively, microphone 24 can be physically detached from housing 12, and coupled, for example, to a user's eyeglasses. In either case, front microphone 24 is configured to extend laterally to a user's facial cheek when worn, and as such, is positioned and adapted to better capture the user's voice. In another embodiment, microphone 24 is coupled elsewhere, for example on a user's lapel, to capture the user's voice. In any event, microphone 24 is in communication with electronic module 20 such that the user's voice is captured by microphone 24, converted to an electrical signal, and is transmitted to electronic module 20.

Hearing assistive device 10 further comprises one or more ambient microphones 26, which can include, for example, a forward facing ambient microphone 26a and a rear facing ambient microphone 26b. Ambient microphones 26 are disposed within housing 12, connected to electronic module 20, and are adapted to receive ambient sound. Because ambient microphones 26 cam be disposed at a surface or within housing 12, boom 22 can extend away from the ambient microphones and be configured to capture or receive different sounds than those captured by microphone 24 attached on or disposed within boom 22.

FIG. 1C shows hearing assistive device 30, similar to hearing assistive device 10 from FIGS. 1A and 1B. In hearing assistive device 30, housing 12 and boom 22 can be integrally formed as a single unit that contains electronic module 20, front facing microphone 24, and ambient microphones 26. For hearing assistive device 30, occlusive earpiece 14 is coupled to housing 12 and the occlusive earpiece can be fit to a user's ear as described above with respect to FIGS. 1A and 1B.

FIG. 1D shows hearing assistive device 34, similar to hearing assistive device 10 from FIGS. 1A and 1B and hearing assistive device 30 from FIG. 1C. In hearing assistive device 34, housing 12 and occlusive earpiece 14 can be integrally formed as a single unit that contains electronic module 20, front facing microphone 24, and ambient microphones 26. As such, no portion of housing 12 need be disposed over or behind a user's ear or outer ear such as a helix of the ear. As with hearing assistive device 10, hearing assistive device 34 includes boom or arm 22 that is coupled to housing 12 or occlusive earpiece 14. A directional front facing microphone 24 can be attached to or disposed within a distal end of boom 22 that is positioned opposite housing 12 and occlusive earpiece 14. Front microphone 24 is configured to extend lateral to a user's facial cheek when worn and as such is positioned to better capture the user's voice. The user's voice is captured by microphone 24 and converted to an electrical signal, which is then transmitted to electronic module 20. Hearing assistive device 34 can be fit at a user's ear as described above with respect to FIG. 1A.

Hearing assistive devices 10, 30, and 34 can be worn comfortably behind the ear, in the outer ear, or within the ear canal to dampen ambient sound with occlusive earpiece 14. A user can adjust an ambient sound signal from one or more ambient microphone 26 according to the user's preference and transmit the adjusted ambient sound signal through speaker 16 into the user's ear through sound projection point 18. A tone (low and high frequencies) and gain (volume) of the ambient sound signal can be adjusted either manually or automatically according to a standard or user specific arrangement so that the user can hear preferentially enhanced sounds at a comfortable tolerance level. In an embodiment, preferential amplification of a signal can be performed, such as amplifying higher frequencies corresponding to the vocal range, where hearing loss typically can be most severe. Accordingly, ambient noise is substantially prevented from directly arriving at a user's inner ear such that the user can control a volume of the ambient noise heard, thereby reducing unwanted ambient noise that makes conversations in crowded environments difficult. In an embodiment, active noise reduction such as noise cancellation technology or other electronic means can be used to provide noise reduction to the user. In an embodiment, passive and active noise reduction provides a NRR to the user in a range of about 5-30 decibels (dB), and in some instances in a range of about 25-30 dB, thereby allowing a user to better function and engage in conversation in environments with high levels of background noise.

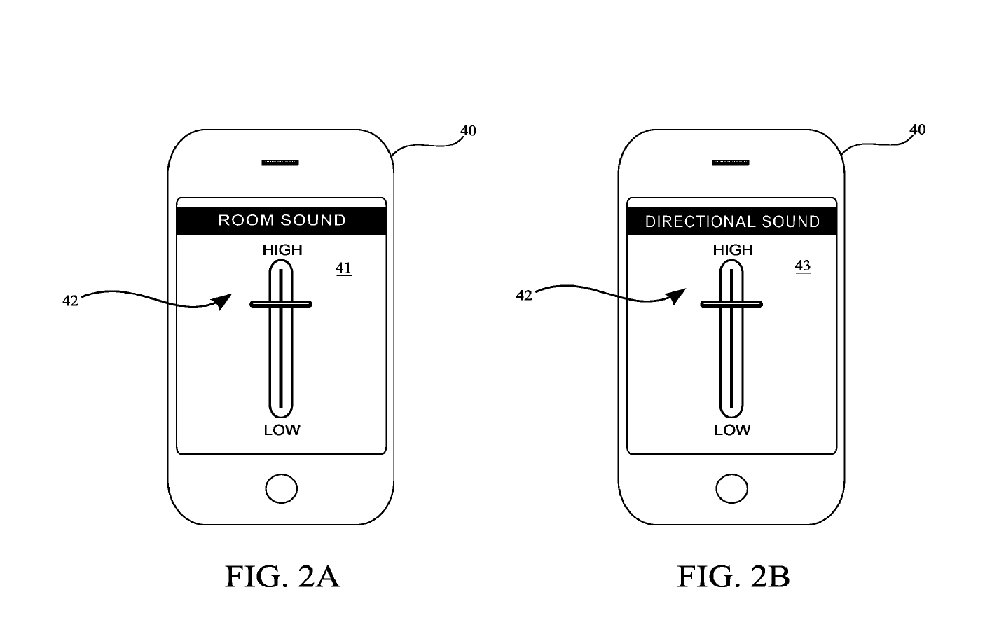

FIG. 2A shows that the ambient noise heard by a user can be controlled by adjusting a sound signal transmitted to the user by speaker 16. Control of the adjusted ambient sound can be executed manually or electronically. FIGS. 2A and 2B show a smart phone or handheld portable electronic communications device 40 that is in communication with electronic module 20 within hearing assistive device 10, 30, or 34. FIG. 2A shows an application or software 42 on smart phone 40 can include a screen 41 that provides a user interface that allows the user to select a level of ambient or environmental sound that passes to the ear after being received by ambient microphones 26, thereby permitting situational awareness while limiting distractions and assisting in conversation with other individuals in a crowded environment. In an embodiment, application 42 provides for a touch screen slider control to selectably adjust one or more attributes of the ambient sound signal received by ambient microphones 26.

Similarly, FIG. 2B shows a screen 43 within application 42 that provides for a touch screen slider control to selectably adjust one or more attributes of a sound signal received by a directional or other microphone such as front facing microphone 24.

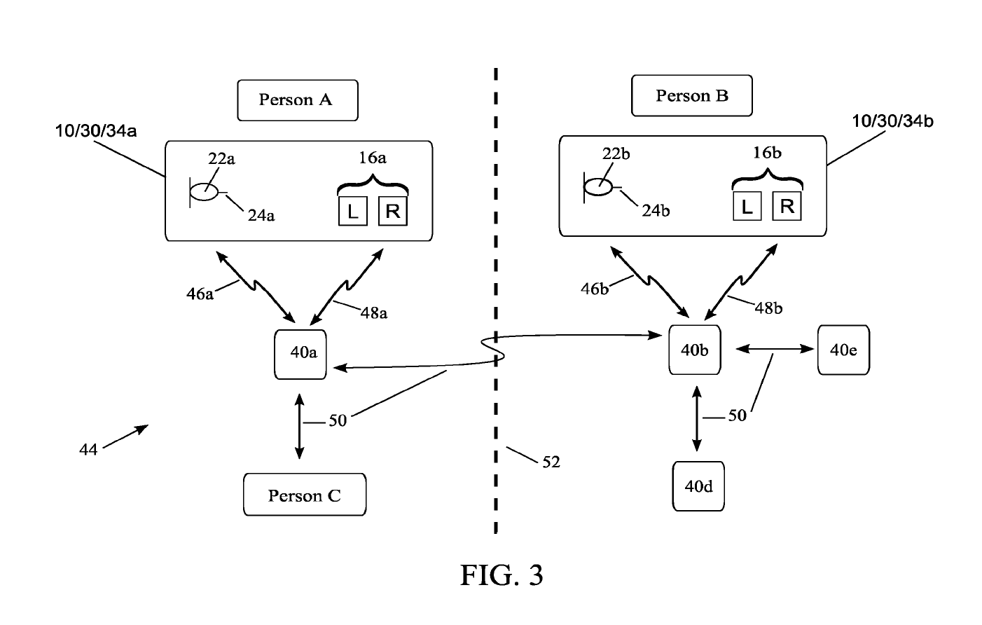

FIG. 3 shows a schematic representation of how one or more hearing assistive devices 10, 30, or 34 and smart phones 40 can be interconnected in a system 44 for improving a user's ability to engage in conversation by selectively screening and enhancing sound that is heard by the user. FIG. 3 shows one or more hearing assistive devices 10a, 30a, or 34a and smart phone 40a associated with a first user, Person A. The one or more hearing assistive devices 10a, 30a, or 34a are linked by wireless or Bluetooth communication connection 46a that supports transmission of signals between smart phone 40a and directional microphone 24a, which can optionally be mounted to boom 22a as discussed above. Similarly, the one or more hearing assistive devices 10a, 30a, or 34a are also linked by wireless or Bluetooth communication connection 48a that supports transmission of signals between smart phone 40a and speakers 16a, which can be worn in a user's left and right ears for bilateral applications such as when a user requires hearing assistance in both ears. As described above with respect to FIGS. 2A and 2B, wireless communication channel 48a allows for a user to selectably adjust one or more attributes of a sound signal received by a microphone, such as directional microphone 24 or ambient microphones 26 from one or more sources, before it is transmitted to a user through speakers 16a.

Furthermore, FIG. 3 also shows one or more hearing assistive devices 10b, 30b, or 34b and smart phone 40b associated with a second user, Person B. Smart phone 40a and smart phone 40b are linked by wireless or Bluetooth communication connection 50. Importantly, system 44 can accommodate groups of any number of users and is not limited to only two users, as discussed in greater detail below. As such, system 44 can provide for communication connection 50 to be established among a plurality of users, for example Persons A-E, through a single common smart phone, for example 40a, or through multiple smart phones, for example 40a, 40b, 40d, and 40e, as determined by the capability of smartphones 40 and communication links 50. While five persons, Persons A-E, are used as a non-limiting example, any number of persons can be included within a group. FIG. 3 shows communication connection 50 supports transmission of signals between smart phone 40a and 40b, and accordingly supports transmission of signals between directional microphones 24 and speakers 16 of multiple users, such as Person A and Person B. The transmission of signals between smartphones can be by full duplex channels. Accordingly, if Person A is engaged in conversation with Person B in a noisy environment in which ambient noise would limit Person A, who is hearing-impaired, to understand Person B, system 44 can improve Person A's ability to converse with Person B. In an embodiment, occlusive earpieces 14 worn by Person A would reduce and limit most sound, including ambient sound, from being heard. Person A could then select a desirable amount of ambient sound by adjusting the signal transmitted from ambient microphones 26 through speaker 16 as shown in FIG. 2A. Additionally, Person A could select a desirable amount of directional sound captured by directional microphone 24 by adjusting the signal transmitted from ambient microphones 26b through one or more smart phones, such as smart phone 40a and 40b, and then to speakers 16a. Person A could select a volume and quality of sound transmitted from directional microphone 24b as described above and with relation to FIG. 2B. Because directional microphone 24b is directed toward and positioned closely with respect to Person B's mouth, the sound captured by directional microphone 24b produces a signal that more clearly captures the speech of Person B than would otherwise be captured if Person A were relying on microphones 26 located at or near Person A's ears. Advantageously, directional microphone 24b can be part of hearing assistive devices 10, 30, or 34, or can be a separate unit attachable, for example, to a user or the user's clothing. Thus, users employing hearing assistive devices 10, 30, or 34 and smart phone 40 as shown in system 44 will benefit from significantly improved signal-to-noise ratios between a user's voice as captured by a directional microphone 24 and ambient or environmental sound captured through ambient microphones 26 by using hearing assistive devices 10, 30, or 34 as transceivers equipped to both send and receive audio signals among users via smart phones 40.

FIG. 3 also shows a filter or security feature 52 that regulates communication between the plurality of smart phones in system 44. Filter 52 can be part of application 42 and requires an access code or password for a user to transmit and receive communication signals from another user's smart phone or hearing assistive devices in order to protect user privacy. The access code may be relayed to a plurality of other users that wish to enter the access code and communicate with other users through a designated channel or talk group, as is discussed in greater detail below.

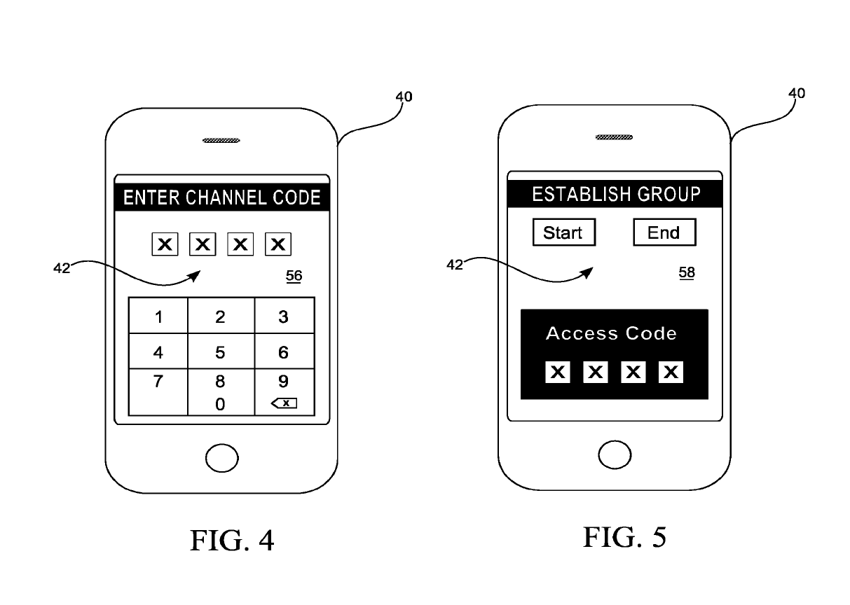

FIG. 4 shows a sample screen 56 within application 42 that allows for entry of an access code to establish a communication link 50 with another user or a channel that can be accessed by another user for the communication and transmission of audio signals. The access code used for establishing or connecting to the communication link 50 can be an alphanumeric sequence of any length, a biometric measurement such as voice or fingerprint recognition, or any other type of access code. As shown in FIG. 4, the access code can include a predetermined four number code that can be either user selected or application generated and shared among users. By creating a channel or access code within screen 56, a privacy protection function is established that allows for users to access or join the channel through communication link 50 by entering the designated access code. In addition to a user selected or user generated channel or access code, other access codes can be accepted by application 42 when establishing communication link 50. For example, application 42 might also recognize as acceptable access code information stored from previous conversation or from saved user settings.

FIG. 5 shows, in relation to FIGS. 3 and 4, a sample screen 58 within application 42 that allows for creation of a talk group that further includes optional access code protection. By establishing a group or talk group, a forum or group node is established that allows a plurality of users, each equipped with a smart phone, user interface, or microphone, to join the talk group and engage in audio communication, such as conversation, while controlling a balance of ambient and user specific audio signals.

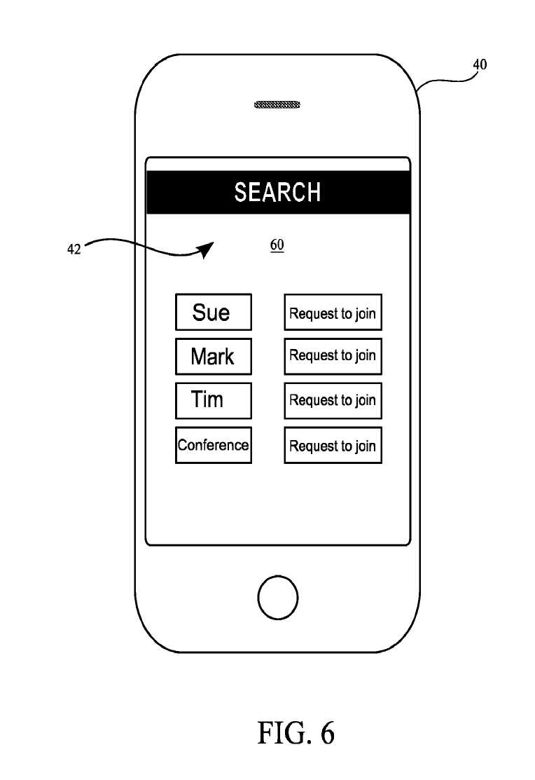

Continuing from FIG. 5, FIG. 6 shows a sample search screen 60 within application 42 that displays a listing of available channels or groups. In an embodiment, a user's smart phone 40 uses application 42 to search for other users with smart phone phones 40 running application 42, or an application compatible with application 42, and can establish a connection through a search function or contact list using Bluetooth or other wireless technology. Application 42 then generates sample screen 60 that displays a list of potential users with which communication links 50 have been or can be established. Establishment of a link can be unilateral or multilateral. For multilateral establishment, which can afford greater privacy, a two-step approach can be utilized by first sending a request or invite to an identified potential user. The invitee then accepts the request and the communication link is established. Sample screen 60 illustrates a possible embodiment of the request by providing a button, toggle, switch, or other selector that allows a user to send a request to the other user. For example, sample screen 60 shows four potential users for a local area: Sue, Mark, Tim, and Conference. By touching the “Request to join” button adjacent to any of the potential users, a request to establish a communication link 50 is made.

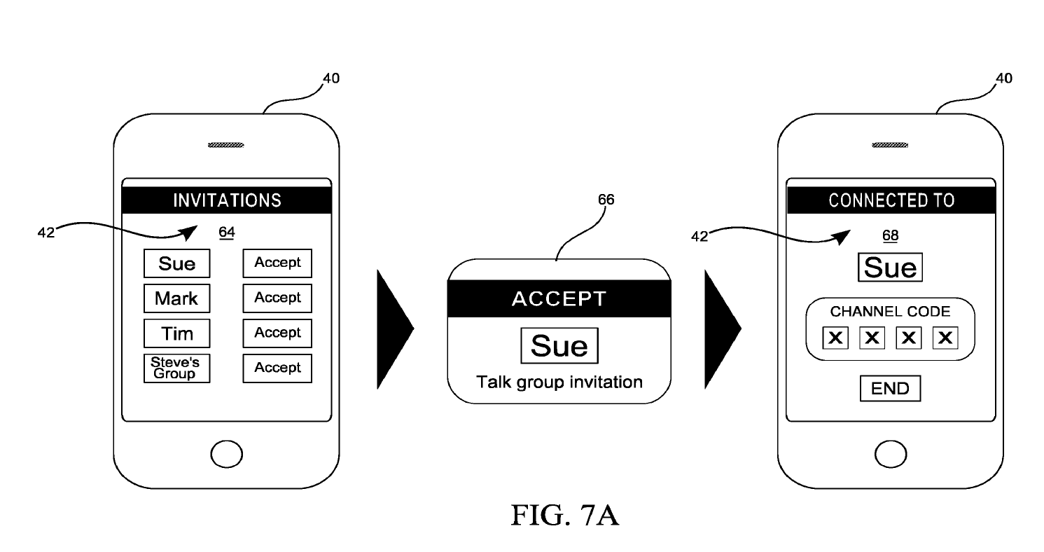

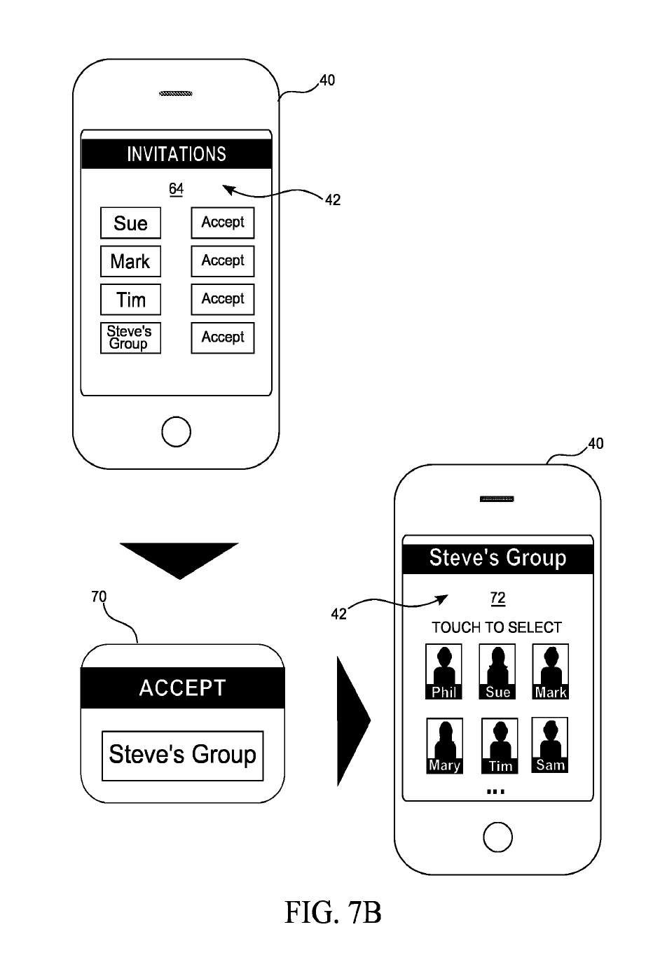

FIGS. 7A-7B, continuing from FIG. 6, show screen 64 of application 42 displaying a number of invitations or requests received by smart phone 40. The received requests shown on screen 64 are sent as described above with respect to FIG. 6. A user can then accept an invitation to establish or secure a communication link 50 with another user by selecting the accept button disposed next to an identifier showing who has made the request. FIG. 7A shows that in an embodiment, the user accepts Sue's invitation by performing action 66. Upon performing action 66, application 42 can display a sample screen 68 that shows an active or secured connection has been established with the desired user, such as Sue. A channel code can also be entered or required as part of establishing connection 50 with a user, such as Sue, which is also indicated on sample screen 68.

FIG. 7B shows a user accepts an invitation to join a group by performing action 70. Upon performing action 70, application 42 can display a sample screen 72 that shows an active connection has been established with the desired group, such as Steve's Group. A channel code can also be entered or required as part of establishing connection 50 with a group. Screen 72 shows an active connection to a conversation group in which connection to the group provides the user with a choice of one or more links that can be selected within the group. Selecting a link within the group allows a user to focus on conversing with a particular individual within the group without needing to establish multiple individual connections or needing to reestablish a connection after a pause in conversation or a tangential conversation with another member of the group. Thus, once accepted into a group conversation, each user may independently open links to one or more other participants within the talk group during the course of the conversation. In an embodiment, a link to one or more participants or users within the group can be established using voice recognition software. For example, a user might say the name of another member of the group. Application 42 would then recognize the name as a member of the group and send an invitation to open an independent link with that participant within the group. An audio signal might also be sent to the user along with the request to indicate another user is inviting them to engage in a direct dialogue.

In addition, application 42 can also access data stored on smartphone 40, such as contact lists and thumbnail pictures, and utilize the data in the application, for example, by adding thumbnail pictures of other users within sample screens such as screen 72 shown in FIG. 7B.

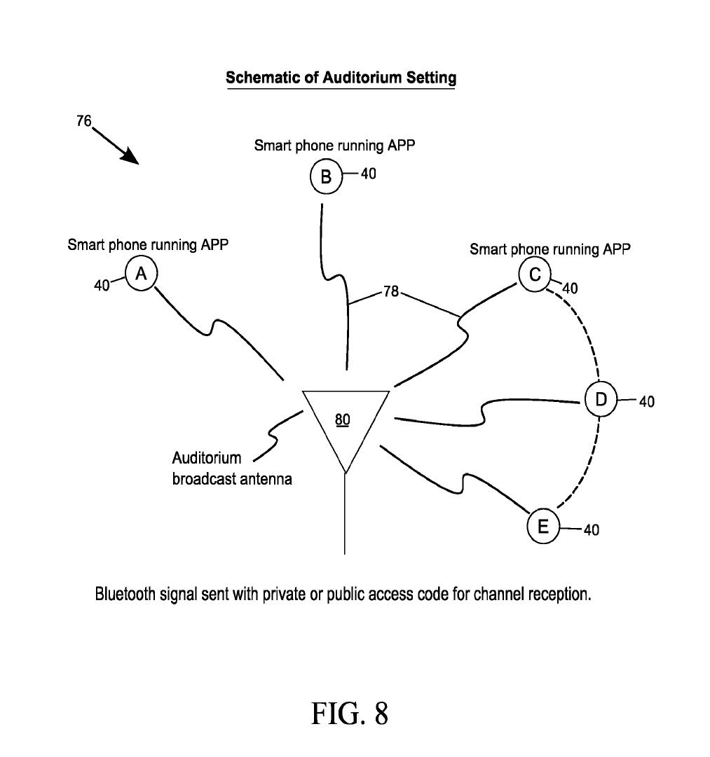

FIG. 8 shows a system 76 similar to system 44 show in FIG. 3. However, instead of having multiple hearing assistive devices 10/30/34 connected to each other through smart phones 40, FIG. 8 shows the additional detail of smart phones 40 wirelessly connected to a broadcast signal 78 that is transmitted from an auditorium broadcast device 80 such as an antenna. Broadcast device 80 can include a central high power Bluetooth transmitter. An access code is optionally required for a user to connect to broadcast signal 78, which can be entered through application 42 in a process similar to the process illustrated in FIG. 4. Alternatively, broadcast signal 78 can be over an open signal and not require an access code. The auditorium broadcast signal can be an available channel shown in application 42 on a screen similar to screen 64 shown in FIGS. 7A-7B. The connection between individual smart phones 40 and broadcast device 80 can be unidirectional such that broadcast device only transmits a signal to smartphones but is not configured to receive a signal. Alternatively, system 76 is configured with a device that includes side channels to receive input or responses from audience member including from smartphones 40 for special situations such as question and answer sessions.

In the foregoing specification, various embodiments of the disclosure have been described. It will, however, be evident that various modifications and changes may be made thereto without departing from the broader spirit and scope of the inventions as set forth in the appended claims. The specification and drawings are, accordingly, to be regarded in an illustrative sense rather than a restrictive sense.

1. A hearing assistive device comprising:
a housing;
an electronic module disposed within the housing;
an occlusive earpiece coupled to the housing;
a speaker connected to the electronic module for projecting sound into an ear of a user;
a first microphone coupled to the housing and connected to the electronic module; and
a second microphone configured to be in communication with the electronic module.

2. The hearing assistive device of claim 1, wherein at least a portion of the housing is disposed behind or over the ear of the user.

3. The hearing assistive device of claim 1, wherein the first microphone is located at a rear portion of the housing and is adapted to receive ambient sound.

4. The hearing assistive device of claim 1, further comprising:
a boom coupled to the housing and extending away from the first microphone; and
the second microphone coupled to the boom and adapted to receive sound from a voice of the user.

5. The hearing assistive device of claim 4, wherein the occlusive earpiece is configured to conformally occlude an ear canal of the user and dampen a volume of ambient sound arriving at the ear canal.

6. A method of using the hearing assistive device of claim 5, comprising:
disposing a rear portion of the housing behind the ear of the user;
disposing at least a portion of the occlusive earpiece within the ear canal; and
extending the second microphone coupled to the boom across a cheek of the user in a direction of a mouth of the user.

7. A method of using the hearing assistive device of claim 5, comprising:
dampening ambient sound with the occlusive earpiece by 5-30 decibels;
adjusting an ambient sound signal from the first microphone according to a preference of the user; and
transmitting the adjusted ambient sound signal through the speaker into the ear of the user.

8. A method of using the hearing assistive device of claim 4, comprising:
receiving an ambient noise signal from the first microphone;
receiving a user voice signal from the second microphone;
modifying the ambient noise signal by subtracting the user voice signal; and
transmitting the modified ambient noise signal to the speaker.

9. A method of using the hearing assistive device of claim 4, comprising:
receiving an ambient noise signal from the first microphone;
receiving an auditorium signal;
combining the ambient noise signal and the auditorium voice signal based on a user input; and
transmitting the combined ambient noise signal and auditorium signal to the speaker.

10-12. (canceled)

13. A hearing assistive device comprising:
a housing;
an electronic module disposed within the housing;
a speaker connected to the electronic module for projecting sound into an ear of a user;
a first microphone coupled to the housing and connected to the electronic module; and
a second microphone coupled to the housing and connected to the electronic module; and
a third microphone configured to be in communication with the electronic module.

14. (canceled)

15. (canceled)

16. The hearing assistive device of claim 13, further comprising:
a boom coupled to the housing and extending away from the first microphone; and
the second microphone coupled to the boom and adapted to receive sound from a voice of the user.

17. A method of using a hearing assistive device, comprising:
receiving a first audio signal from an ambient microphone;
receiving a second audio signal from a directional microphone;
mixing the first and second audio signals according to a preference of the first user; and
projecting the mixed first and second audio signals into an ear of the first user.

18. The method of claim 17, further comprising:
dampening ambient sound arriving directly at the ear of the first user by disposing an occlusive earpiece within the ear to reduce the ambient sound by 5-30 decibels; and
projecting the mixed first and second audio signals from a speaker into the ear of the first user to indirectly provide a desired volume of ambient sound to the ear of the first user.

19. The method of claim 17, wherein receiving the second audio signal further includes receiving a voice of a second user engaged in conversation with the first user.

20. The method of claim 17, further including mixing the first and second audio signals according to the preference of the first user that is defined by an input entered by the first user into a program executed by a handheld wireless communication device.

21. The method of claim 20, further including entering the input into the program by a voice recognition feature of the program.

22. The method of claim 19, further including:
receiving the second audio signal through a wireless handheld communication device before mixing the second audio signal according to the preference of the first user; and
entering an access code before receiving the second audio signal.

23. (canceled)

24. The method of claim 17, further including:
forming a group through connecting a plurality of handheld wireless communication devices; and
receiving the second audio signal through the group; and
selecting the second audio signal from among a plurality of audio signals available through the group.

25. The method of claim 17, further comprising establishing a security enabled group between at least first and second wireless communication devices to facilitate transmission of signals between multiple hearing assistive devices.

26. The method of claim 17, further comprising:
providing access to the second audio signal from the directional microphone to a group comprising a plurality of users through a wireless communication device; and
requesting access to the second audio signal by saying a name of a second user associated with the second audio signal such that the application sends an invite to the second user.

27. (canceled)

28. (canceled)
